(19) United States
(12) Patent Application Publication
(10) Pub. No.: US 2008/0028574 A1
(43) Pub. Date: Feb. 7, 2008

(54) Integral Composite Piano Hinge, Composite, Assemblies With An Integral Piano Hinge, And Methods Of Manufacture

(76) Inventors: Patrick E. Mack, Milford, MA (US); Greg Grisevich, Allston, MA (US)

Correspondence Address: Brian M. Dingman;Mirick, O'Connell, DeMallie & Lougee, LLP, 1700 West Park Drive, Westborough, MA, 01581, US

(21) Appl. No.: 11/833,326

(22) Filed: Aug. 3, 2007

Related U.S. Application Data
(60) Provisional application No. 60/821,616, filed on Aug. 7, 2006.

(51) Int. Cl. E05D 9/00

(52) U.S. Cl. 16/385; 428/188

(57) ABSTRACT

An integral composite piano hinge assembly, and a method of making such an assembly. The assembly is made from a series of separate plies that are saturated with hardened resin to define a multi-layer composite structure, and a series of interleaved knuckles made from one or more composite tubes located within the plies such that at least one ply lies below the tube and at least one ply lies above the tube. The piano hinge may be an integral part of a structure such as a transom bracket.

### CROSS REFERENCE TO RELATED APPLICATION

This application claims priority of Provisional Patent Application Ser. No. 60/821,616, filed on Aug. 7, 2006, the entire disclosure of which is incorporated herein by reference.

### FIELD OF THE INVENTION

The present invention relates to the manufacture and use of an integral composite piano hinge, and assemblies with such a hinge.

### BACKGROUND OF THE INVENTION

Hinges are used to connect two relatively movable parts. Piano hinges are elongated hinges with a series of interspersed tubular knuckles, with a hinge pin passing through the knuckles. Piano hinges are typically metallic. However, there are applications (such as corrosive environments) in which metallic piano hinges can't be used, or the metals that can be used are relatively expensive. Also, metals are relatively dense, making metallic piano hinges relatively heavy.

Composite hinges, made of fiber/epoxy composite materials, can solve both the corrosion and weight problems. However, composite hinges are typically difficult and rather expensive to manufacture, so have not been commonly used.

One example in which a composite piano hinge would be useful is in a trim tab for a powerboat. Trim tabs, which consist of an adjustable trim plane mounted on the stem or transom of the boat, serve to level the boat while under way by providing lift to the transom to counter the acceleration-induced bow rise. This lift, or upward pressure, is the result of the Bernoulli effect of fluid moving over a plane inclined relative to the path of motion. As the angle at which the trim plane enters the water increases, the lift on the trim plane also increases, raising the stern and thus leveling the boat. In this manner, maximum speed, efficiency, and smoothness of ride are produced through reduced hydrodynamic and wind resistance.

The current state of the art relies on the use of metallic trim planes, often of stainless steel and in some cases aluminum. While these materials may meet the physical demands of the application, they do so with a considerable weight penalty. Additionally trim plane design latitude is often hampered by the practical limits of metal fabrication. The need exists for a lighter trim plane manufactured in a manner that allows wider design latitude.

### SUMMARY OF THE INVENTION

The invention provides a composite piano hinge, and methods of making composite piano hinges. The invention also includes useful composite structures with integral piano hinges. One non-limiting example embodiment of a composite structure in accordance with the invention is a trim tab for a powerboat. The inventive devices have many of the advantages mentioned herein, and many novel features that result from the use of composite materials which are not anticipated, rendered obvious, suggested, or even implied by the prior art.

In view of the foregoing disadvantages inherent in the known types of trim tab trim plane materials now present in the prior art, the present invention provides a new technique for trim tab fabrication using composite materials. The inventive trim tab incorporates an integral piano hinge that connects the transom bracket to the trim plane.

Before explaining embodiments of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of the present invention is to provide a new technique for fabrication of piano hinges, and assemblies and structures using piano hinges, with composite materials. A second object of the present invention is to provide a means of incorporating an integral transom bracket to trim plane piano hinge in the fabrication of the composite trim tab. A third object of the present invention is to provide fabrication methods that increase structural design latitude over the current state of the art by virtue of the use of composite materials.

These and other objects and advantages of the present invention will become readily apparent upon further review of the following specification and drawings and it is intended that these objects and advantages be within the scope of the present invention.

To the accomplishment of the above and related objects, this invention may be embodied in the forms illustrated in the accompanying drawings, attention being called to the fact, however, that the drawings are illustrative only, and that changes may be made in the specific construction illustrated.

This invention features a composite trim tab assembly comprising a composite transom bracket, a composite trim plane, and a composite piano hinge connecting the trim plane to the transom bracket, to allow relative movement between the trim plane and the transom bracket. The piano hinge may comprise a series of interleaved knuckles, with some of the knuckles an integral part of the transom bracket and other knuckles an integral part of the trim plane. The knuckles may be made from one or more composite tubes. The knuckles may be made from a single tube that is cut to define the knuckles. The transom bracket and the trim plane may be made from a single multi-layer composite structure, with the tube located between distinct layers of the composite structure. The knuckles may be made from two composite tubes. These two tubes may be proximate to one another. The transom bracket and the trim plane may be made from a single multi-layer composite structure, with the tubes located between distinct layers of the composite structure. One of the layers may comprise a three-dimensional spacer fabric.

This invention also features an integral composite piano hinge assembly comprising a series of separate plies that are saturated with hardened resin to define a multi-layer composite structure, and a series of interleaved knuckles made from one or more composite tubes located within the plies such that at least one ply lies below the tube and at least one ply lies above the tube. The knuckles may be made from a single tube that is cut to define the knuckles, or the knuckles may be made from two composite tubes that are proximate to one another and cut to define the knuckles. At least one of the layers may comprise a three-dimensional spacer fabric.

This invention further features a method of manufacturing an integral composite piano hinge assembly comprising laying up in a mold a series of separate plies that define a multi-layer composite preform, locating one or more composite tubes in the preform such that at least one ply lies below the tube and at least one ply lies above the tube, consolidating the preform (which now includes the one or more tubes) under vacuum pressure, introducing into the consolidated preform a liquid resin to fully saturate the preform with resin, maintaining the vacuum while the resin hardens to produce a consolidated composite assembly, cutting the assembly along the one or more tubes to produce a series of knuckles, interleaving the knuckles, and introducing a hinge pin through the knuckles. At least one of the plies may comprise a three-dimensional spacer fabric.

### BRIEF DESCRIPTION OF THE DRAWINGS

Various other objects, features and advantages of the present invention will become fully appreciated as the same becomes better understood when considered in conjunction with the accompanying drawings, in which like reference characters designate the same or similar parts throughout the several views, and wherein:

FIG. 1 is a cross section of a simple form of composite trim tab with integral transom bracket to trim plane piano hinge according to this invention, before it is cut into separate trim tab and transom bracket pieces;

FIGS. 2A, 2B and 3 illustrate steps in the process for producing the composite trim tab of FIG. 1;

FIG. 4 is a plan view of the composite trim tab produced according to the process illustrated in FIGS. 2 and 3 following cutting of the loops to form the knuckles of the two hinge half portions;

FIG. 5 is an isometric view of the trim tab of FIG. 4;

FIG. 6 is an exploded view of the trim tab assembly using the trim tab of FIGS. 1-5;

FIG. 7 is an isometric view of the assembled trim tab of FIG. 6;

FIG. 8 is a plan view of another embodiment of a composite trim tab of the invention following cutting of the loops to form the knuckles;

FIG. 9A is an isometric view of a back draft damper of the invention that includes an inventive integral composite piano hinge; and

FIG. 9B is an isometric view of the damper of FIG. 9A in place in an exhaust duct.

### DETAILED DESCRIPTION OF EMBODIMENTS OF THE INVENTION

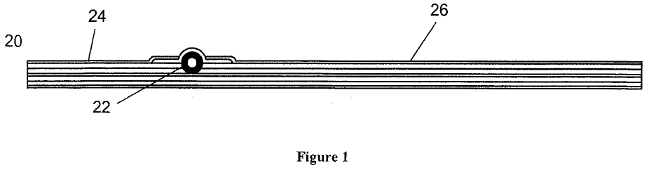

Referring to the drawings, FIG. 1 illustrates a cross section of a simple form of composite trim tab 20 according to the invention. Integral trim tab 20 comprises composite loop (tube) 22, and two outwardly extending flat or planar composite plates made of multiple layers or plies of composite material. One plate forms the transom bracket 24, and the other forms trim plane 26. Loop 22 is comprised of a prefabricated tube, preferably formed by pultrusion and having integral carbon fibers.

In an alternate embodiment of the invention the fabrication of loop 22 is facilitated by use of a removable insert or mandrel, removed after fabrication of the integral planar plate making up bracket 24 and trim plane 26, rather than a separate inserted tube 22.

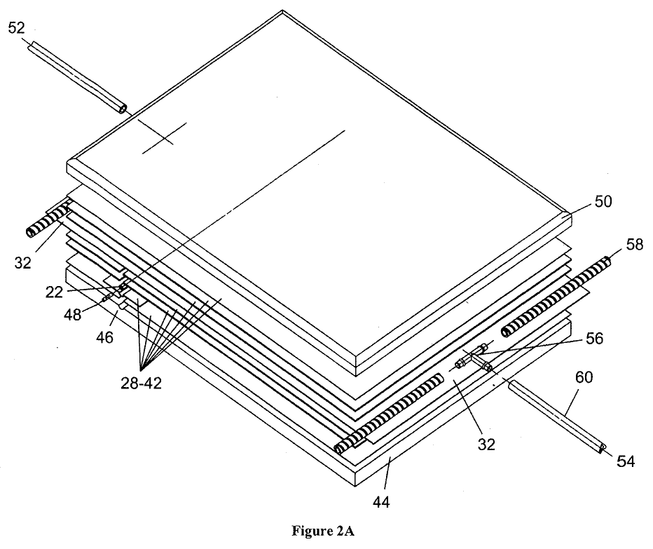

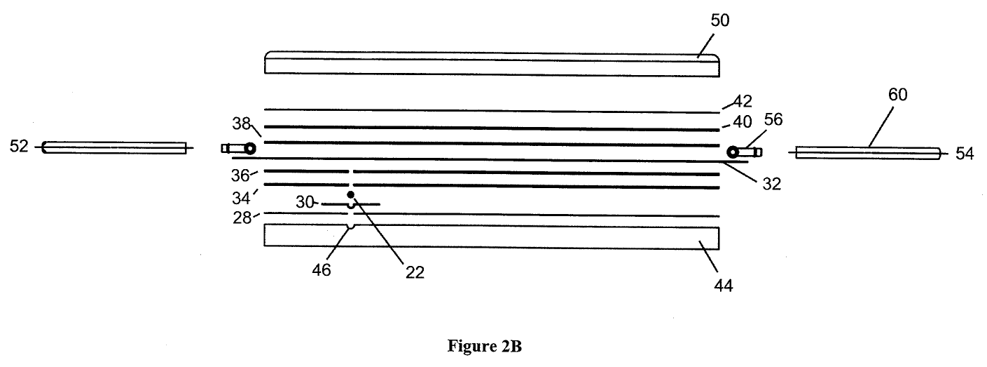

Referring to FIGS. 2A and 2B of the drawings, the composite trim tab 20 of the invention is produced preferably by the interlaminar vacuum infusion process, wherein the prefabricated cured composite loop tube 22 is capped with an insert 48 with an outer diameter that matches the inner diameter of tube 22 such that the tube is sealed from resin infiltration. The then capped tube 22 is placed within the composite ply sequence (also called a “preform” herein) comprising dry laminae 28, 30, 32, 34, 36, 38, 40 and 42, within a two part tool (mold) in of which one half 44 contains a trough 46 to receive the prefabricated loop tube, while the opposing half 50 remains planar relative to the opposing planar surface of plate 44. In an alternate embodiment of the invention, both plate 44 and plate 50 contain a receiving trough relative to the loop tube and laminae. In yet another embodiment of the invention both plate 44 and plate 50 remain planar to each other.

To enable the resin infusion process, infusion flow reinforcement layer 32 is placed within the laminae of the preform. The use of a three-dimensional spacer fabric such as disclosed in U.S. Pat. No. 7,048,985 (the disclosure of which is incorporated herein by reference) is preferable with respect to the trim tab fabrication as the fabric can be designed to impart damage tolerance to the composite structure. In the preferred embodiment, the spacer fabric is Polybeam® 703 fabric from Polynova Composites, Milford, Mass. Polybeam is made from thermoplastic fibers (typically made from PET). The thermoplastic material, particularly in the transverse (or “Z direction”) fibers, provides a vibration damping characteristic to the structure that includes the fabric. HIFLUX90™, also available from Polynova Composites, is made from high tenacity PET and so would also impart such damping characteristics. As trim tabs are inherently subject to substantial stresses, the spacer fabric may increase the useful life of the trim tab. As taught in the patent incorporated herein by reference, the spacer fabric also speeds resin distribution through the preform, which decreases the manufacturing cost. The infusion flow reinforcement 32 is extended beyond the two opposing edges of tool 44 and 50 such that contact with resin inlet 52 and vacuum outlet 54 is maintained where inlet 52 and outlet 54 are each made up of a tee connector 56, spiral wrap 58, and tubing 60.

Referring to FIG. 3 in this example the assembly of FIGS. 2A and 2B is placed on surface 62 and surrounded by a two-sided sealant tape 64 over which a flexible vacuum bag (not shown in the drawings) is placed, thus forming a vacuum envelope. Sealant tape 64 is placed over tube 54 at location 66, thereby providing a means of communication within the envelope without breaking the vacuum bag seal. Inlet 52 is then closed and vacuum pressure is applied through tube 54 to collapse the flexible vacuum bag under atmospheric pressure against the assembly. The vacuum serves to consolidate the assembly via atmospheric pressure, thereby shaping the fibers in the mold, and to remove any entrapped air. Resin is then introduced into the envelope via inlet 52, and the vacuum serves to draw the resin through the fiber pre-form via the three-dimensional spacer fabric. Vacuum pressure is maintained until the laminate is fully saturated with resin and subsequently cures.

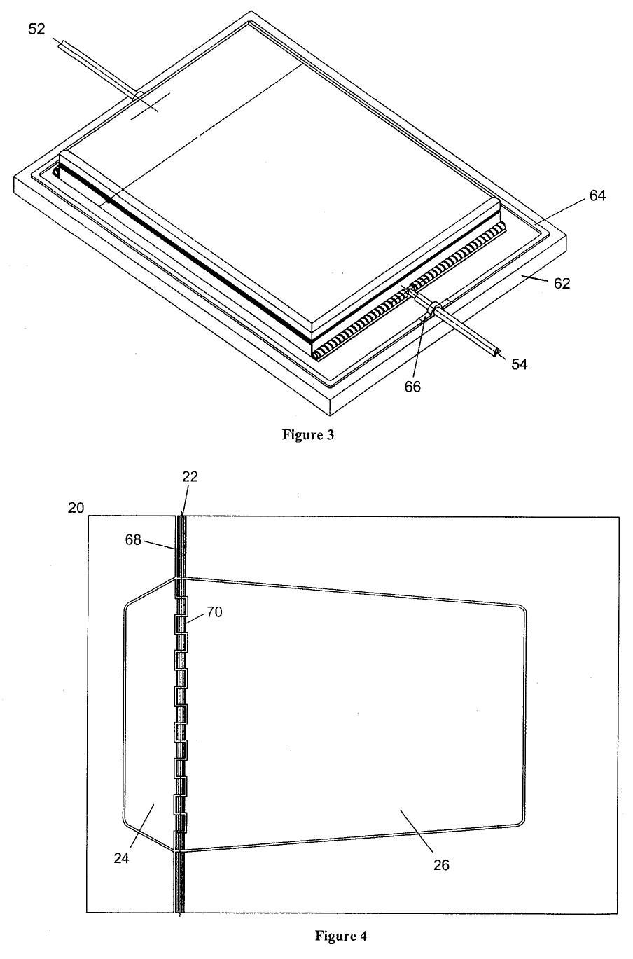

Referring to FIG. 4, loop tube 22 of composite 20 is cut as illustrated by gap 68 via water jet or other means to provide an aligned series of evenly spaced tubular knuckles 70 formed integrally along the mating edges of the transom bracket 24 and the trim plane 26. FIG. 5 is an isometric view of FIG. 4.

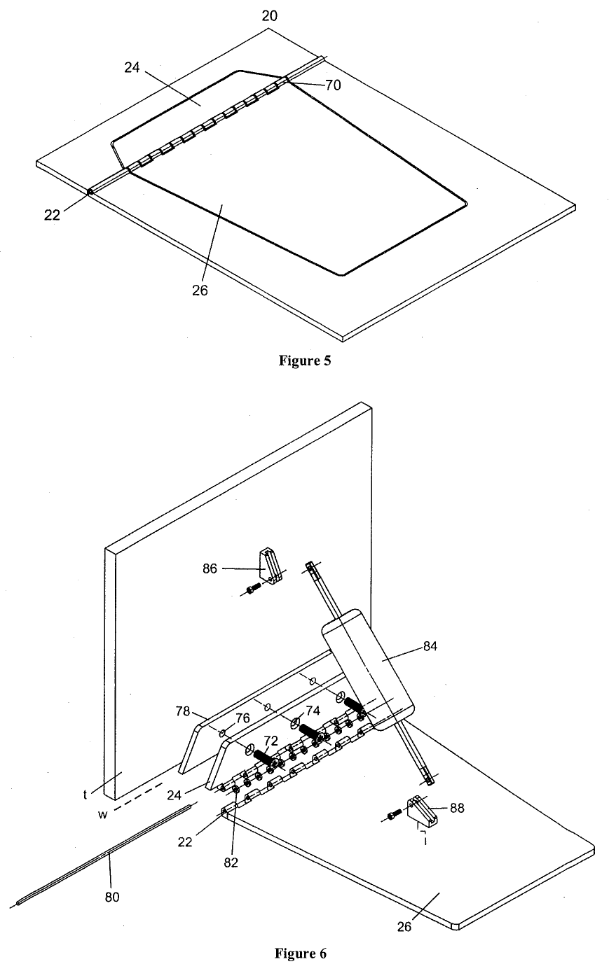

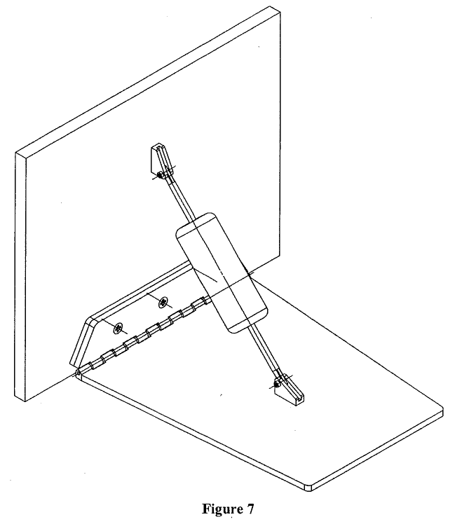

FIG. 6 is an exploded view of a trim tab assembly incorporating composite trim tab 20. Bracket 24 is adapted to be mounted on the transom “t” of a boat near the surface of the water “w”. Bracket 24 is attached to the transom by fasteners 72 passing through openings 74, then through openings 76 of blacking plate 78.

The trim plate 26 is pivotally mounted to the transom bracket 24 at mating tubular knuckle 70 and held in place with hinge pin 80. The diameter of hinge pin 80 matches the inner diameter of loop 22. Pin 80 is preferably made of pultruded carbon fiber. As loop 22 is a cured composite tube, it will not consolidate as the preform is cured. This allows the tube to remain open to its normal diameter. In contrast, the use of a prepreg tube subjects the tube to consolidation (collapse) during the autoclave cure process, thus requiring a mandrel to be used in the tube to keep the tube open through the cure cycle. The mandrel is an extra step, and can also be very difficult to remove due to the clamping force on the mandrel caused by tube collapse. Horizontal movement of trim plane 26 is restricted by the use of bushings 82 placed in the spaces between the hinge knuckles created by the cutting process. Angular penetration of the trim plane to the water surface is facilitated by an actuator 84 attached to the transom via bracket 86 and to the trim plane via bracket 88.

FIG. 7 is an isometric view of the assembled trim tab of FIG. 6.

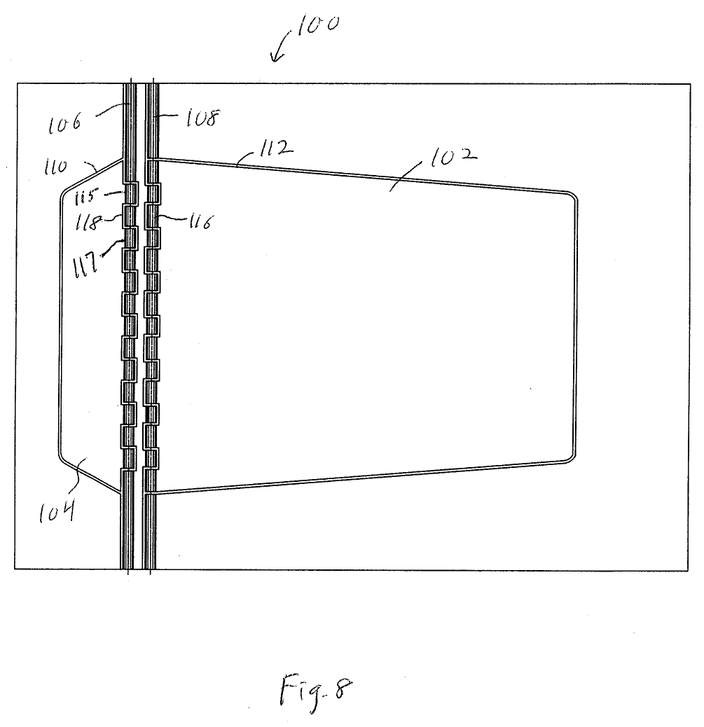

FIG. 8 is a plan view of an alternative embodiment of a trim tab for the invention. Trim tab assembly incorporating integral trim tab 100 includes two identical closely spaced loop tubes 106 and 108. Loop tube 106, when cut as shown by gap 110, defines the series of spaced knuckles on the edge of transom bracket 104, while loop tube 108, when cut as shown by gap 112, defines the series of spaced mating knuckles on the edge of trim plane 102. The use of two loop tubes allows the removal of alternate lengths from each tube (for example, length 118 between knuckles 115 and 117) that, together with the two end cuts that define the ends of the removed length, is the same length as a knuckle, to provide a space into which an adjacent knuckle from the other half of the hinge just fits. Thus, adjacent interleaved knuckles (for example knuckles 115, 116 and 117) are long enough such that the gap between adjacent knuckles in the assembled hinge is very small. This may allow the hinge assembly to forego the use of bushings that in the first embodiment are used to inhibit relative horizontal movement of the transom bracket and trim plane.

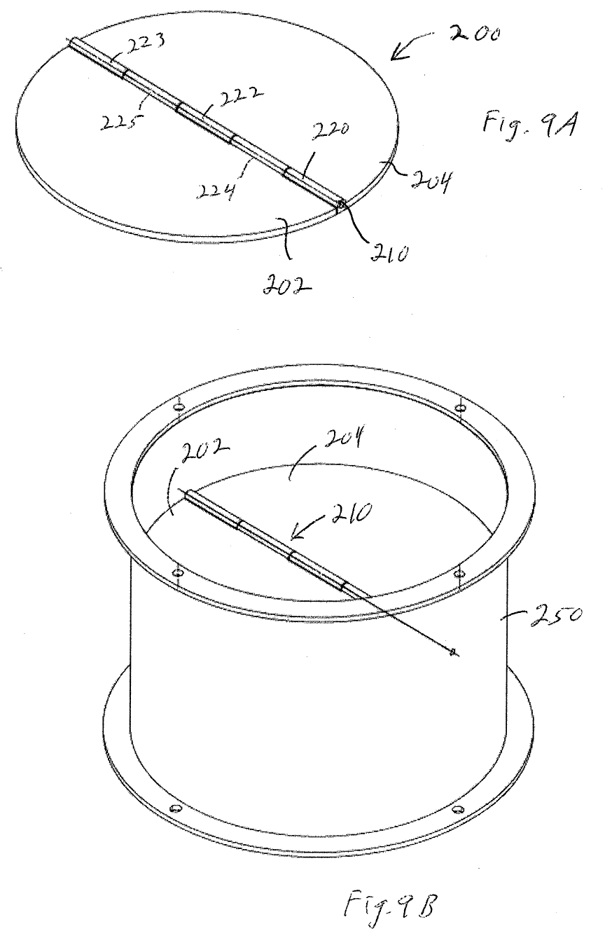

FIGS. 9A and 9B show another example of an assembly using an inventive composite piano hinge. Back draft damper assembly 200 includes plates 202 and 204 joined by piano hinge 210. Assembly 200 can be made in the same manner as the transom bracket described herein. Piano hinge 210 comprise knuckles 220, 222 and 223 that are on the inner edge of one of plates 202 and 204, and interleaved knuckles 224 and 225 that are on the inner edge of the other of these plates. Piano hinge 210 allows the plates to pivot relative to one another about the longitudinal axis of the hinge, so that the open area within exhaust tube 250 can be controlled as desired. One application of this is to close tube 250 when the exhaust fan (not shown) is off, to prevent a backdraft down the exhaust tube. Composite damper assembly 200 is corrosion resistant and can be made to provide insulating properties over the metal sheets currently used as dampers.

The invention is applicable to any assembly that can use a piano hinge and would benefit by having a composite hinge (whether or not the rest of the assembly is itself made from composite material). For example, a composite hinge that could be fastened to non-composite members could be fashioned to have a shape similar to damper assembly 200, but likely with rectangular shaped plates adjacent the hinge rather than the semicircular plates shown in FIGS. 9A and 9B. Such plates could be screwed or bolted to the members that are being connected by the composite hinge.

Alternatively, as is the case with the two exemplary assemblies shown in the drawings, the entire assembly can be fabricated of composite material. In this case, preferably the assembly would be made integrally as described above, and then separated into relatively moveable parts such as by cutting through the composite, also as described above. Alternatively, the two relatively moveable parts could each be integral and manufactured separately, and then connected together by the hinge pin.

### Non-Limiting Example of the Invention

The following is an example of a simple form of composite trim tab with integral transom bracket to trim plane piano hinge 20 of the invention.

Referring to FIG. 2A and FIG. 2B, where tool 44 and tool 50 are 11.75″×16″ in dimension, the dry laminae (28 through 42) in the preform before resin introduction consisted of 0.75 oz./ft.² chopped strand mat (Owens Corning M723A) 28, E-LT 1800 (Vectorply) 30, 0.196″ OD 0.118″ ID carbon fiber loop tube 22 (Air Dyne) capped at both ends with a 0.118″ OD solid insert 48 such that the tube is sealed from resin infiltration, 42 oz./yd. 3WEAVE (3TEX) 34 and 36, Polybeam® 703 (Polynova Composites) 32, 42 oz./yd.² 3WEAVE (3TEX) 38 and 40, and 0.75 oz./ft.² chopped strand mat (Owens Corning M723A) 42.

Upon assembly of the laminae (28 through 42), a vacuum port 54 consisting of a single 0.375″ (ID) vacuum tube 60 fitted to a tee 56, with 0.25″ ID spiral wrap 58 was placed in contact with the infusion flow reinforcement. The spiral wrap 58 maintains an open contact with the infusion flow reinforcement during processing. A like resin port 52 was placed across from vacuum port 54.

Referring to FIG. 3, a flexible vacuum bag was then fitted and sealed about the tool 44 and 50, the resin input tube 52 was sealed with a clamp, and vacuum was drawn. A gauge affixed to a standard resin trap read the vacuum, generated by a Dekker RVL020H rotary vane pump. When vacuum was stabilized at 29 inches of mercury the clamp was removed from the resin inlet tube, and the tube was subsequently placed in a vessel containing initiated vinyl ester resin (250 cPs Novoc 4020 Resin (initiated with 1% Norac Norox CHP)). The resin clamp was reaffixed to the inlet tube when the resin front reached the vacuum port (17 minutes) and the laminate was allowed to cure under vacuum. This results in a laminate that is fully saturated with resin and cured under vacuum, that remains consolidated after the resin fully cures and hardens.

A comparison of the properties of type 304 stainless steel, a common trim tab material, and the calculated properties of the above example composite trim tab are presented in Table 1.

TABLE 1

| | | High Strength | |
|---|---|---|---|
| Property | Unit | Steel | Example 1 |
| Thickness | Inches | 0.105 | 0.218 |
| Weight | Lbs./ft.² | 4.39 | 2.06 |
| 0° Tensile Strength (Ultimate) | kSI | 42.1 | 35.4 |
| 90° Tensile Strength (Ultimate) | kSI | 42.1 | 35.4 |
| 0° Flexural Stiffness | lb-in | 3,123 | 2,116 |
| 90° Flexural Stiffness | lb-in | 3,123 | 2,623 |

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A composite trim tab assembly, comprising:
a composite transom bracket;
a composite trim plane; and
a composite piano hinge connecting the trim plane to the transom bracket, to allow relative movement between the trim plane and the transom bracket.

2. The composite trim tab assembly of claim 1 in which the piano hinge comprises a series of interleaved knuckles, with some of the knuckles an integral part of the transom bracket and other knuckles an integral part of the trim plane.

3. The composite trim tab assembly of claim 2 in which the knuckles are made from one or more composite tubes.

4. The composite trim tab assembly of claim 3 in which the knuckles are made from a single tube that is cut to define the knuckles.

5. The composite trim tab assembly of claim 4 in which the transom bracket and the trim plane are made from a single multi-layer composite structure, with the tube located between distinct layers of the composite structure.

6. The composite trim tab assembly of claim 3 in which the knuckles are made from two composite tubes.

7. The composite trim tab assembly of claim 6 in which the tubes are proximate to one another.

8. The composite trim tab assembly of claim 6 in which the transom bracket and the trim plane are made from a single multi-layer composite structure, with the tubes located between distinct layers of the composite structure.

9. The composite trim tab assembly of claim 1 in which the transom bracket and the trim plane are made from a single multi-layer composite structure.

10. The composite trim tab assembly of claim 9 in which at least one of the layers comprises a three-dimensional spacer fabric.

11. An integral composite piano hinge assembly, comprising:
a series of separate plies that are saturated with hardened resin to define a multi-layer composite structure; and
a series of interleaved knuckles made from one or more composite tubes located within the plies such that at least one ply lies below the tube and at least one ply lies above the tube.

12. The integral composite piano hinge assembly of claim 11 in which the knuckles are made from a single tube that is cut to define the knuckles.

13. The integral composite piano hinge assembly of claim 11 in which the knuckles are made from two composite tubes.

14. The integral composite piano hinge assembly of claim 13 in which the tubes are proximate to one another.

15. The integral composite piano hinge assembly of claim 11 in which at least one of the layers comprises a three-dimensional spacer fabric.

16. A method of manufacturing integral composite piano hinge assembly, comprising:
laying up in a mold a series of separate plies that define a multi-layer composite preform;
locating one or more composite tubes in the preform such that at least one ply lies below the tube and at least one ply lies above the tube;
consolidating the preform along with the one or more tubes under vacuum pressure;
introducing into the consolidated preform a liquid resin to fully saturate the preform with resin;
maintaining the vacuum while the resin hardens, to produce a consolidated composite assembly;
cutting the assembly along the one or more tubes to produce a series of knuckles;
interleaving the knuckles; and
introducing a hinge pin through the knuckles.

17. The method of claim 16 in which at least one of the plies comprises a three-dimensional spacer fabric.
